(19) United States
(12) Patent Application Publication
(10) Pub. No.: US 2013/0096958 A1
(43) Pub. Date: Apr. 18, 2013

(54) METHODS OF SELLING ENDOWMENT POLICIES

(71) Applicant: David Joseph Fier, Rye Brook, NY (US)

(72) Inventor: David Joseph Fier, Rye Brook, NY (US)

(21) Appl. No.: 13/514,846

(22) PCT Filed: Jul. 12, 2010
(86) PCT No.: PCT/US10/41692

§ 371 Date: Aug. 29, 2012

Related U.S. Application Data
(60) Provisional application No. 61/285,560, filed on Dec. 11, 2009.

(51) Int. Cl. G06Q 40/08

(52) U.S. Cl. CPC G06Q 40/08
USPC 705/4

(57) ABSTRACT

Methods of selling endowment policies and funding an education are provided. In a general embodiment, the method includes selling a first endowment policy to an individual, allowing the individual to purchase additional endowment policies at the same price as the first endowment policy, and reminding the individual using an automatic computer generated reminder of the right to purchase additional endowment policies. The endowment policies can be used to fund an education.

### BACKGROUND

The present disclosure is directed to sales and marketing. More specifically, the present disclosure is directed to methods of selling endowment policies and funding education.

There are many types of insurance policies that cover a wide range of subjects such as auto, home, fire, and life. Insurance can allow a policy holder to pay specified sums to prevent a large, possibly devastating loss. An insurance company typically sells the insurance policies to the insured or policyholder. An insurance rate is a factor used to determine the amount to charge the policy holder for a certain amount of insurance coverage.

Another type of insurance involve an endowment policy. An endowment policy is a type of life insurance policy designed to pay a lump sum after a specified term (on its “maturity”) or on earlier death of the insured.

### SUMMARY

The present disclosure is directed to methods of selling endowment policies and methods of funding a college or other type of education with endowment policies. In a general embodiment, the method of selling endowment policies comprises selling a first endowment policy to an individual, allowing the individual to purchase one or more additional endowment policies at the same price as the first endowment policy, and reminding the individual of the right to purchase additional endowment policies.

In an embodiment, the reminder is a process including premium notices, email statements, mail statements or a combination thereof. The reminder can be on an annual or a semi-annual basis.

In another embodiment, the present disclosure provides a method of selling endowment policies. The method comprises selling a first endowment policy to an individual for funding an education of a second individual and maintaining a database in a computer of relevant information including premium price, date of purchase, and individual information. The method further comprises allowing the individual to purchase one or more additional endowment policies at the same price as the first endowment policy for funding the education of the second individual, generally using the database as a reminder for the individual of the right to purchase the additional endowment policies, and sending the reminder to the individual.

In an embodiment, the individual will be allowed to purchase up to a maximum of four additional endowment policies at the same price as the first endowment policy. Each of the endowment policies can insure the same beneficiary. There can be a maximum amount of insurance that is covered by the sum of the individual endowment policies.

In an alternative embodiment, the present disclosure provides a method of selling endowment policies comprising determining whether an individual qualifies for a first endowment policy based on a blood profile, a home office specimen, and/or a physical examination. The method further comprises selling the first endowment policy to the individual if the individual qualifies, allowing the individual to purchase one or more additional endowment policies at the same price or different price as the first endowment policy, and reminding the individual using an automatic computer generated reminder of the right to purchase additional endowment policies.

In yet another embodiment, the present disclosure provides a computer implemented method of selling endowment policies. The method comprises providing an interface for an individual to enter information about the individual and a first endowment policy and determining whether the individual qualifies for the first endowment policy using a computer process configured to process the information. The method further comprises selling the first endowment policy to an individual if the individual qualifies, allowing the individual to purchase one or more additional endowment policies at the same price or different price as the first endowment policy, and reminding the individual using an automatic computer generated reminder of the right to purchase additional endowment policies.

In an embodiment, the interface is part of a computer. The computer is connected to a central processing station. The reminding can be done by a process such as premium notices, email statements, mail statements or a combination thereof.

In an embodiment, the information includes one or more physical characteristics and/or mental characteristics of the individual. Determining whether the individual meets the qualifications for the first endowment policy can involve analyzing one or more risk factors of the individual. The risk factor can include age, heart condition, cancer, diabetes, drug use, alcohol use, blood pressure, mental disorder, nervous disorder, blood disorder, kidney condition, lung condition, intestine condition, criminal history or a combination thereof.

In still another embodiment, the present disclosure provides a method of funding a college education of an individual such as a child, grandchild, nephew, niece, etc. The method comprises purchasing a first endowment policy to fund an individual's college education, obtaining the right with the first endowment policy to purchase one or more additional endowment policies at the same price for a number of years to fund the individual's college education, receiving automatic computer generated reminders of the right to purchase the additional endowment policies, and purchasing an additional endowment in response to the automatic computer generated reminders.

An advantage of the present disclosure is to provide an improved method of selling endowment policies.

Another advantage of the present disclosure is to provide an improved method of multiple endowment policies.

Yet another advantage of the present disclosure is to provide a method of funding an education using endowment policies.

Additional features and advantages are described herein, and will be apparent from the following Detailed Description and the FIGURE.

### BRIEF DESCRIPTION OF THE FIGURE

FIG. 1 is schematic diagram of an exemplary computer device for implementing the method of selling endowment policies in an embodiment.

### DETAILED DESCRIPTION

The present disclosure is directed to methods of selling endowment policies and methods of funding an education with endowment policies. The endowment policies can be structured to pay any suitable lump sum after a specified term and/or on earlier death of the insured. The specified term can be any amount of time such as, for example, ten, fifteen or twenty years up to a certain age limit of the insured. The endowment policy can also be structured to pay out in the case of critical illness of the insured.

In a general embodiment, present disclosure provides a method of selling one or more endowment policies. The method comprises selling a first endowment policy to an individual (e.g., policy owner), allowing the individual to purchase one or more additional endowment policies at the same price as the first endowment policy, and reminding the individual of the right to purchase one or more additional endowment policies. The endowment policies can be sold, for example, by an insurance company or any company in the business of selling endowment policies.

The method allows the policy owner to purchase up to a specified number of additional endowment policies at the same price as the original policy via an additional policy rider including this information. For example, the additional policy rider can allow the policy owner to purchase up to a specified maximum of additional endowment policies at the same price as the first endowment policy. Alternatively, the policy owner can be allowed to purchase up to a specified maximum of additional endowment policies at any designated price specified by the insurance company. This allows the policy owner to stagger the maturities to align with the years the policy owner's individual (or another individual) will be attending college. The premium for the additional policies can be based on the age and/or health of the insured of the original individual endowment policy.

In an embodiment, the endowment policies can be used to pay for college tuition. Because more students are taking 5 years to graduate from college, the policy owner will have the option, for example, to buy up to 4 additional endowment policies under the rider.

In an embodiment, the reminding is via premium notices, email statements, mail statements or a combination thereof sent by the insurance company. The reminding can be done on an annual or a semi-annual basis or any designated time period. The reminding can also be done using an automatic computer generated reminder.

Each of the endowment policies can insure the same beneficiary. Alternatively, one or more of the endowment policies can insure one or more different beneficiaries. There can be a maximum amount of insurance that can be covered by the sum of the individual endowment policies. Each of the individual endowment policies can be for the same or different amounts.

An advantage of the claimed methods is that the policy owner can, using the rider, be able to spread the cost for the endowment policies over a longer period of time helping to better manage cash flow. The premium for the additional endowment policies could be the same as the original endowment policy assuming the same face amount, maturity and underwriting class. Over the life of the endowment policies, this has the potential of saving the policy owner several hundreds of dollars.

Using premium notices, emails and/or annual statements, policy own ers can be reminded that the rider gives them the right to purchase additional policies at a cost savings. Because the name of the policy owner is known and the policy owner can be sent premium notices and annual statements, the cost per converted policy (“CPCP”) should be significantly less than the CPCP of the original individual endowment policy. The cost savings should more than cover the difference in premium waived as the insured ages.

In an example of the claimed method, individual A, age 30, just had a baby. She is very interested in having her child attend a four year college when she is 18 years of age. To help fund her child's education individual A bought an 18 year $10,000 endowment when her daughter was born. Individual A went on to buy another 18 year $10,000 endowment each of the next three years. As individual A's daughter starts college, a policy will mature providing some funding for each year of college. Individual A saves money because she is paying the premium as if she was age 30 for all four policies.

In an embodiment, the policy owner is entitled to purchase one additional individual endowment each year for up to 4 years after the original effective date using the original issue age of the insured. The insured individual should be the same person for all policies. The additional policies can be for the same or smaller face amount and same maturity as the original policy.

In an embodiment, there is no premium charged for the rider. Any additional endowment policy purchased under the rider can have its own premiums.

In an embodiment, the maximum amount of insurance that can be purchased under the rider is “capped” at a maximum amount of insurance available on any one life. For example, the current maximum amount of coverage available on any one life can be a specified amount (e.g., $300,000), which includes the original policy, additional policies bought using the rider, and any other life insurance the insured may have with the insurance company.

In order for the policy owner to exercise the rider and purchase additional endowment policies, the original policy should be in force and all premiums that are due have been paid. The rider may not be added to policies where the insured on the original policy is substandard risk.

In another embodiment, the present disclosure provides a method of selling endowment policies comprising determining whether an individual qualifies for a first endowment policy based on a blood profile, a home office specimen, and/or a physical examination, selling the first endowment policy to the individual, allowing the individual to purchase one or more additional endowment policies, and reminding the individual of the right to purchase additional endo went policies. The determining can be done using a computer processor configured to process the information obtained via the blood profile, the home office specimen, and/or the physical examination of the individual and determine a risk assessment from the information. The reminder can be an automatic computer generated reminder.

The individual can also be assessed to determine whether she/she qualifies for the additional endowment policies. For example, to screen individuals for the additional endowment policies, any time an owner wishes to purchase a policy under the rider the following general question may be asked about the insured: Since applying for your first endowment policy have you received any treatment for or diagnosis of or been advised by a medical professional to have treatment for, heart disease or disorder; cancer or tumor; diabetes; drug or alcohol abuse; high blood pressure or stroke; mental or nervous disorder; or any disorder of the blood, kidneys, liver, lungs, intestines or central nervous system; pneumonia or swollen lymph nodes; Acquired Immune Deficiency Syndrome (“AIDS”) or Human Immunodeficiency Virus (“HIV”) infection or plead guilty to or been convicted of a felony or misdemeanor, or have charges pending against you?

If the response is “no,” the additional policy should be issued if the individual's alpha and MD3 checks are “clear” If the response is yes, the insurance company can request additional information to properly review the risk before issuing another policy at the insured's original issue age and underwriting class. If the insurance company does not think it prudent to issue another policy under the rider because of a significant change in health of the insured, the policy owner should be notified and offered the opportunity to purchase a new policy with a fully underwritten application. An alpha check can also be performed to check against individual limits on coverage.

The rider can be attached to all individual endowment policies issued by the insurance company until such time as it decides to no longer offer the rider. The rider can be added to policies issued prior to the availability of the rider. The rider may not be added to policies where the insured is a substandard risk.

In an embodiment, where the total amount of insurance for all policies owned and/or being applied for is above a specified amount (e.g., $250,001 or more), underwriting can request desired information such as a blood profile, home office specimen (e.g., urine sample), and physical measurements. In addition, if the insured is above a specified age (e.g., 51 or higher) and where the total amount of insurance for all policies owned and/or being applied for is above a specified amount (e.g., $100,001 or more), underwriting can request desired information such as a blood profile, home office specimen and physical measurements.

The rider can be designed to terminate after a specified time (e.g., 5 years) from the effective date of the original/first endowment policy. In addition, the rider can be designed to terminate if the policy owner fails to purchase an additional policy any consecutive periods of time (e.g., two years). For example, if individual A purchased a first endowment policy in year 1, she would have the right, under the rider, to purchase a new endowment for the same face amount and maturity at the original endowments premium for 4 more years. However, if individual A did not buy additional policies in subsequent years, the rider could be designed to terminate.

If the policy owner causes the rider to terminate for non-use, he or she may still be eligible to purchase a new endowment policy subject to full underwriting. Any new purchase, once the rider expires, will have a premium based on the insured's new/attained age and underwriting class.

In an embodiment, the policy owner can have the right to apply for the additional endowment policies under the rider for a specified time period (e.g., 45 days) before and after the anniversary date of the original policy. If the policy owner submits an application within a specified time period (e.g., 90 day) “window,” he or she may be eligible to take advantage of the reduced premium, provided all underwriting requirements are satisfied. Any application received outside the 90 day “window” may not be eligible for the discount provided under the rider.

The methods of the present disclosure may be implemented on any computer readable medium capable that can be incorporated into a computer 10. In an embodiment, the computer readable medium includes, but is not limited to, a memory disk, a CD-ROM, a magnetic tape, a hard-disk drive, flash memory and random access memory (RAM). The methods in embodiments of the present disclosure can be programmed into software or hardware as part of computer 10.

In an embodiment, the present disclosure provides a computer implemented method of selling endowment policies. The method comprises providing an interface for an individual to enter information about the individual and a first endowment policy and determining whether the individual meets the qualifications for the first endowment policy using a computer process configured to process the information. The method further includes selling the first endowment policy to an individual if the individual meets the minimum requirements, allowing the individual to purchase one or more additional endowment policies, and reminding the individual using an automatic computer generated reminder of the right to purchase additional endowment policies.

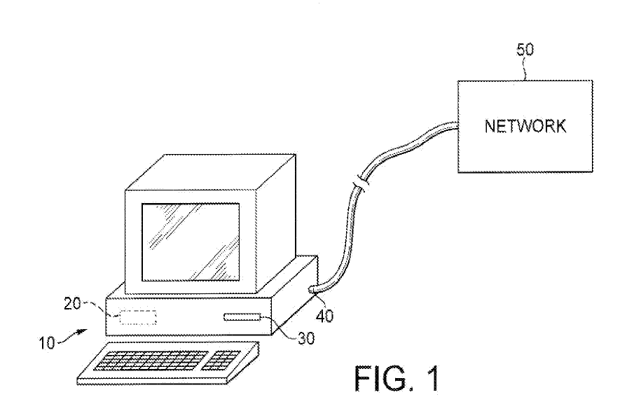

In an embodiment, the interface (e.g., computer monitor) is part of computer 10 operable by the individual or user. As shown in FIG. 1, computer 10 may include an internal storage device 20 (e.g., hard-disk drive) for storing instructions for implementing the methods and/or an external reading device 30 (e.g., USB port) for receiving a computer readable medium (e.g., pin drive) having instructions recorded thereon for causing a processor of the computer 10, upon executing the instructions, to provide the interface for a user to purchase the endowment policies.

A network interface 40 (e.g., local area network (LAN) connection) may also be provided as part of the computer 10 to allow for communication with a network 50 (e.g., internet). The network 50 can include a central processing station or server located, for example, at the insurance company providing the endowment policies. The network interface 40 allows for communication from the user to the central processing station and from the central processing station to the user. The central processing station can also include a database of relevant information including premium price, date of purchase, and individual information that can be used to send the computer generated reminders to the individual having the initial endowment policy.

The central processing station can generate the information needed for the purchase of the endowment policies buy the user. The central processing server can also be programmed to analyze the information from the individual to determine whether the individual qualifies for the endowment policies and to determine the rates/premiums to be paid by the individual. The central processing station can further be set up (e.g., programmed) to automatically general endowment policy reminders to the individual. The reminding can be done by a process such as premium notices, email statements, mail statements or a combination thereof.

In an embodiment, the information provided by the individual includes one or more physical characteristics and/or mental characteristics of the individual. Determining whether the individual meets the qualifications for the first endowment policy can involve analyzing at least one risk factor of the individual. The risk factor can include age, heart condition, cancer, diabetes, drug use, alcohol use, blood pressure, mental disorder, nervous disorder, blood disorder, kidney condition, lung condition, intestine condition, criminal history or a combination thereof.

The analysis can be done using a computer processor configured to process the physical characteristics and mental characteristics along with the risk factors of the individual. A risk assessment can be determined from the information that can then be used by the insurance company in setting, for example, the premiums of the endowment policies.

In yet another embodiment, the present disclosure provides a method of funding an education of an individual. The method comprises purchasing a first endowment policy to fund an individual's college education, obtaining the right with the first endowment policy to purchase one or more additional endowment policies at the same price for a number of years to fund the individual's college education, receiving automatic computer generated reminders of the right to purchase the additional endowment policies, and purchasing an additional endowment in response to the automatic computer generated reminders. This method can be a computer implemented method in accordance with the previous discussion.

### EXAMPLES

By way of example and not limitation, the following examples are illustrative of various embodiments of the present disclosure.

### Example 1

### Sample Rider

### Individual Endowment Additional Policy Rider

Company A has issued this Rider as part of the Policy to which it is attached, provided that the rider is listed on the Policy Specifications page.

The Owner may purchase one additional individual endowment insurance policy on the Insured on each Option Date. The age upon which the premium of each new policy will be based is the age of the Insured as of the date the Policy to which this Rider is attached was issued.

The insurance company will require evidence of insurability for each purchase of an additional endowment insurance policy.

The Policy must be in force on a premium paying basis. The Owner must be the same Owner as of the time the Policy was issued.

This Rider has no cash value. All terms of the Policy which are not inconsistent with this Rider apply to this Rider.

### Option Dates

Option dates are the first, second, third and fourth Policy anniversaries.

### Election of Option

The insurance company must receive your application for the purchase, together with the required additional premium, within 45 days before or after the Option Date.

### Option Amount and Maturity Date

The face amount of each additional endowment policy may not be greater than the Face Amount of the Policy to which this Rider is attached. The maximum face amount that may be purchased on all Option Dates is a total of $300,000.

The duration of each additional endowment policy must the same as the duration of the Policy to which this Rider is attached.

### Effective Date of New Insurance

The new policy purchased under this rider will not be effective until it has been approved and the initial full premium(s) due have been accepted by Us while the proposed insured is alive and all statements and answers in all parts of the application continue to be true and complete. The effective date will be the day all of the conditions stated in this section have been completed to the satisfaction of Company A.

### Termination

This Rider will terminate at the earliest of the following dates:
1. 45 days after the last Option Date,
2. the date the Policy is terminated for any reason, or
3. 45 days after the second consecutive Option Date on which no additional endowment insurance policy is purchased under this Rider.

### Consideration

This benefit is issued in consideration of the application, a copy of which is attached to the Policy. There is no premium for this Rider.

### Effective Date

The effective date of this Rider will the Policy Date, unless a later date is shown below.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of selling endowment policies, the method comprising:
selling a first endowment policy to an individual for funding an education of a second individual;
maintaining a database in a computer of relevant information including premium price, date of purchase, and individual information;
allowing the individual to purchase at least one additional endowment policy at the same price as the first endowment policy for funding the education of the second individual;
generally using the database as a reminder for the individual of the right to purchase the additional endowment policies; and
sending the reminder to the individual.

2. The method of claim 1, wherein the reminding is done by a process selected from the group consisting of premium notices, email statements, mail statements and combinations thereof.

3. The method of claim 1, wherein the reminding is done on an annual basis.

4. The method of claim 1, wherein the individual will be allowed to purchase up to a maximum of four additional endowment policies at the same price as the first endowment policy.

5. The method of claim 1, wherein each of the endowment policies insures the same beneficiary.

6. The method of claim 1, wherein there is a maximum amount of insurance covered by the sum of the individual endowment policies.

7. A method of selling endowment policies, the method comprising:
determining whether an individual qualifies for a first endowment policy based on information comprising at least one of a blood profile, a home office specimen, and a physical examination of the individual, the information of the individual being analyzed by a computer processor configured to process the information;
selling the first endowment policy to the individual if the individual qualifies;
allowing the individual to purchase at least one additional endowment policy; and
reminding the individual of the right to purchase additional endowment policies.

8. The method of claim 7, wherein the individual is assessed to qualify for the additional endowment policies.

9. The method of claim 7, wherein the reminding is done by an automatic computer generated reminder.

10. A computer implemented method of selling endowment policies, the method comprising:
providing an interface for an individual to enter information about the individual and a first endowment policy;
determining whether the individual qualifies for the first endowment policy using a computer process configured to process the information;
selling the first endowment policy to an individual if the individual qualifies;
allowing the individual to purchase at least one additional endowment policy; and
reminding the individual using an automatic computer generated reminder of the right to purchase additional endowment policies.

11. The method of claim 10, wherein the information comprises at least one of physical characteristics and mental characteristics of the individual.

12. The method of claim 10, wherein the interface is part of a computer.

13. The method of claim 10, wherein the computer is connected to a central processing station.

14. The method of claim 10, wherein the reminding is done by a process selected from the group consisting of premium notices, email statements, mail statements and combinations thereof.

15. The method of claim 10, wherein the reminding is done on an annual basis.

16. The method of claim 10, wherein the individual will be allowed to purchase up to a maximum of four additional endowment policies at the same price as the first endowment policy.

17. The method of claim 10, wherein each of the endowment policies insures the same beneficiary.

18. The method of claim 10, wherein determining whether the individual qualifies for the first endowment policy involves analyzing at least one risk factor of the individual.

19. The method of claim 18, wherein the risk factor is selected from the group consisting of age, heart condition, cancer, diabetes, drug use, alcohol use, blood pressure, mental disorder, nervous disorder, blood disorder, kidney condition, lung condition, intestine condition, criminal history and combinations thereof.

20. A method of funding an education, the method comprising:
purchasing a first endowment policy to fund an individual's college education;
obtaining the right with the first endowment policy to purchase additional endowment policies at the same price for a number of years to fund the individual's college education;
receiving automatic computer generated reminders of the right to purchase at least one additional endowment policy; and
purchasing the at least one additional endowment policy in response to the automatic computer generated reminders.
